(19) United States
(12) Patent Application Publication
(10) Pub. No.: US 2020/0017987 A1
(43) Pub. Date: Jan. 16, 2020

(54) MAST AND EXPOSED GEARS ARE ZINC-HIGH-NICKEL PLATED FOR GREATER ABRASION AND/OR CORROSION RESISTANCE

(71) Applicant: Bell Textron Inc., Forth Worth, TX (US)

(72) Inventors: Scott David Poster, Arlington, TX (US); Gregory Kenneth Haataja, Haltom City, TX (US)

(21) Appl. No.: 16/510,051

(22) Filed: Jul. 12, 2019

Related U.S. Application Data
(60) Provisional application No. 62/696,402, filed on Jul. 11, 2018.

(51) Int. Cl. C25D 3/56; B64C 27/12; F16H 57/02

(52) U.S. Cl. CPC C25D 3/565; C25D 3/562; F16H 2057/02039; F16H 57/02; F16H 2057/02017; B64C 27/12

(57) ABSTRACT

A rotorcraft component protected from abrasion or corrosion includes the rotorcraft component and a zinc-nickel coating on at least a portion of a surface of the rotorcraft component, wherein the zinc-nickel coating protects the portion of the surface of the rotorcraft component from abrasion or corrosion. The rotorcraft component is a main rotor mast, a tail rotor mast, a gear, a main rotor gearbox, or one or more gears in an accessory gearbox, a reduction gearbox, an intermediate gearbox, or a tail rotor gearbox.

### CROSS-REFERENCE TO RELATED APPLICATIONS

This patent application claims priority to U.S. provisional patent application Ser. No. 62/696,402 filed on Jul. 11, 2018 entitled “Mast and Exposed Gears are Zinc-High-Nickel Plated for Greater Abrasion and/or Corrosion Resistance” which is hereby incorporated by reference in its entirety. This patent application is related to U.S. provisional patent application Ser. No. 62/399,067 filed on Sep. 23, 2016 entitled “Improved Helicopter Transmission System”, U.S. provisional patent application Ser. No. 62/423,371 filed on Nov. 17, 2016 entitled “Improved Helicopter Transmission System,” and U.S. patent application Ser. No. 15/709,502 filed on Sep. 20, 2017 entitled “Fan Mounted on Gearshaft”, all of which is hereby incorporated by reference in its entirety.

### STATEMENT OF FEDERALLY FUNDED RESEARCH

Not applicable.

### TECHNICAL FIELD OF THE INVENTION

The present invention relates in general to the field of rotorcraft, and more particularly to methods and systems for preventing wear and/or corrosion to rotorcraft systems.

### BACKGROUND OF THE INVENTION

Without limiting the scope of the invention, its background is described in connection with rotorcraft drive systems.

Since their inception, rotorcraft and rotorcraft drive systems have been improved to reduce the possibility of failure during flight. Toward that end, a number of modifications have been made to drive systems to improve reliability. However, despite advances in materials and design, a number of failures continue to occur that affect rotorcraft performance. One example of a problem with current rotorcraft drive systems is that, in some instances, the failure of single drive system component leads to failure of the entire drive system.

Thus, a need remains for improving the overall safety and reliability of rotorcraft drive systems that include the connections between the engines and the main rotor gearbox, reduction and accessory gearboxes, shafts, generators, oil pumps, and accessories connected to the main rotor gearbox.

Existing methods and apparatuses for protecting components subject to abrasion and/or corrosion in operation such as a main rotor mast, a tail rotor mast, and gears can be improved on to lengthen their operational lives and to reduce the frequency with which the components must be inspected and replaced. If a gear driving element abrades, for example, its functionality can be reduced to the point of failure, so such parts must be inspected relatively frequently and replaced when necessary to prevent such failures. Methods and apparatuses for better protecting components from abrasion and/or corrosion are desirable.

### SUMMARY OF THE INVENTION

In one embodiment, the present invention includes a rotorcraft component protected from abrasion or corrosion, comprising: the rotorcraft component; and a zinc-nickel coating on at least a portion of a surface of the rotorcraft component, wherein the zinc-nickel coating protects the portion of the surface of the rotorcraft component from abrasion or corrosion. In one aspect, the zinc-nickel coating has a high nickel content, wherein a nickel content of the zinc-nickel coating is about 12 to 18%. In another aspect, a nickel content of the zinc-nickel coating is about 18%. In another aspect, a nickel content of the zinc-nickel coating is about 15 to 18%. In another aspect, a zinc content of the zinc-nickel coating is about 3 to 8%. In another aspect, the rotorcraft component is a main rotor mast, a tail rotor mast, a gear, a main rotor gearbox, or one or more gears in an accessory gearbox, a reduction gearbox, an intermediate gearbox, or a tail rotor gearbox.

In another embodiment, the present invention includes a method of protecting a rotorcraft component from abrasion or corrosion, comprising: providing the rotorcraft component; and coating at least a portion of a surface of the rotorcraft component with a zinc-nickel coating. In one aspect, the zinc-nickel coating has a high nickel content, wherein a nickel content of the zinc-nickel coating is about 12 to 18%. In another aspect, a nickel content of the zinc-nickel coating is about 15 to 18%. In another aspect, a nickel content of the zinc-nickel coating is about 18%. In another aspect, a zinc content of the zinc-nickel coating is about 3 to 8%. In another aspect, the rotorcraft component is a main rotor mast, a tail rotor mast, a gear, a main rotor gearbox, or one or more gears in an accessory gearbox, a reduction gearbox, an intermediate gearbox, or a tail rotor gearbox.

In another embodiment, the present invention includes a rotorcraft, comprising: a fuselage; one or more engines coupled to the fuselage; and a component coupled to the one or more engines, comprising a zinc-nickel coating on at least a portion of a surface of the component, wherein the zinc-nickel coating protects the portion of the surface of the component from abrasion or corrosion. In one aspect, the zinc-nickel coating has a high nickel content, wherein a nickel content of the zinc-nickel coating is about 12 to 18%. In another aspect, a nickel content of the zinc-nickel coating is about 18%. In another aspect, a nickel content of the zinc-nickel coating is about 15 to 18%. In another aspect, a zinc content of the zinc-nickel coating is about 3-8%. In another aspect, the component is a main rotor mast, a tail rotor mast, a gear, a main rotor gearbox, or one or more gears in an accessory gearbox, a reduction gearbox, an intermediate gearbox, or a tail rotor gearbox.

In addition to the foregoing, various other method, system, and apparatus aspects are set forth in the teachings of the present disclosure, such as the claims, text, and drawings forming a part of the present disclosure.

The foregoing is a summary and thus contains, by necessity, simplifications, generalizations, and omissions of detail. Consequently, those skilled in the art will appreciate that this summary is illustrative only and is not intended to be in any way limiting. There aspects, features, and advantages of the devices, processes, and other subject matter described herein will be become apparent in the teachings set forth herein.

### BRIEF DESCRIPTION OF THE DRAWINGS

For a more complete understanding of the features and advantages of the present invention, reference is now made to the detailed description of the invention along with the accompanying figures, in which:

FIG. 1 shows a side view of a helicopter according to a particular embodiment of the present application;

FIG. 2 shows a partial cross-section, perspective view of a helicopter according to an embodiment of the present application;

FIG. 3 shows depicts a main rotor transmission system in which a main rotor mast is protected from abrasion or corrosion by zinc-nickel coating;

FIG. 4 depicts a tail rotor transmission system in which a tail rotor mast is protected from abrasion or corrosion by zinc-nickel coating;

FIG. 5A illustrates an interior view of an example gearbox in which the exposed or driving element of the gears are protected from abrasion or corrosion by zinc-nickel coating;

FIG. 5B illustrates a cross-sectional view of an example gearbox in which the exposed or driving element of a gear is protected from abrasion or corrosion by zinc-nickel coating; and

FIG. 6 shows a flowchart of a method embodiment of protecting a component from abrasion with zinc-nickel coating.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention addresses the problems with drive systems in use today that are known to lead to rotorcraft failure. More particularly, the drive system of the present invention was designed to overcome drive system failures wear, abrasion, and/or corrosion. The present invention is of particular use to reduce maintenance of the main and tail rotor masts as well as gears that are part of the drive train by reducing the wear and/or corrosion on those components. More particularly, the new rotorcraft drive system is focused in an unparalleled manner on safety and redundancy. The goal of safety drove the design and development of the unique layout, materials, and configuration of the rotorcraft drive system described herein, which incorporates unique features and system separation that protects primary aircraft systems from the most common drive system failures.

For this reason, the present invention includes a powertrain for a rotorcraft that includes coatings that reduce the wear and/or corrosion on gears and are more wear resistant than the cadmium coatings used in the art. One such coating includes a high nickel content. As used herein, the term “high nickel content” in the present invention includes a range of about 12 to 18, 15 to 18, 15 or 18 weight percent (wt %) nickel.

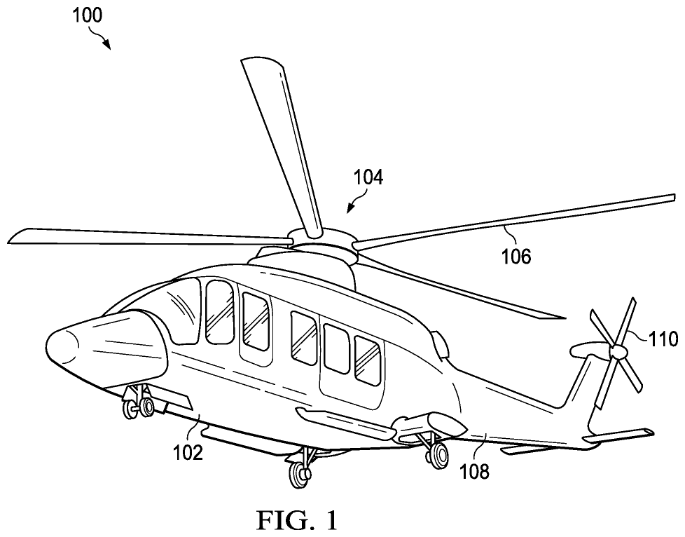

FIG. 1 shows an aircraft 100 in accordance with a preferred embodiment of the present application. In the exemplary embodiment, aircraft 100 is a helicopter having a fuselage 102 and a rotor system 104 carried thereon. A plurality of rotor blades 106 is operably associated with a rotor system 104 for creating flight. A tail boom 108 is depicted that further includes tail rotor 110.

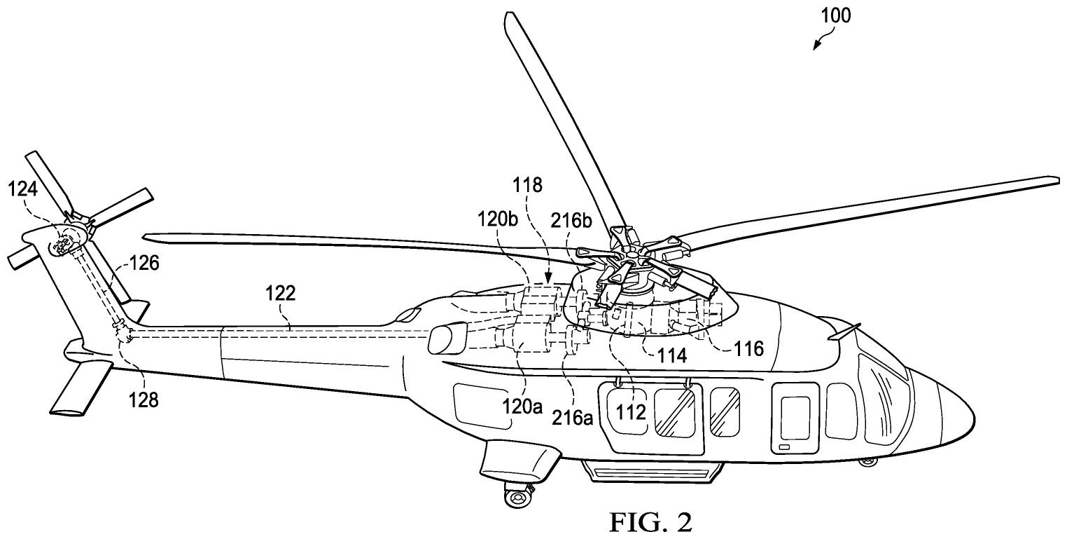

For example, FIG. 2 shows a partial cross-section perspective view of aircraft 100 that includes additional detail of the present invention. Aircraft 100 further includes a main rotor mast 112, which is connected to the main rotor gearbox 114. The main rotor gearbox 114 is connected to one or more accessory gear boxes 116 and one or more reduction gearboxes 216a, 216b. Each reduction gearbox 216a, 216b is connected to one or more engines 120a, 120b, which are within an engine compartment 118. A tail rotor drive shaft 122 transmits mechanical rotation to the tail rotor gearbox 124, which is connected via tail rotor drive shaft 126 and intermediate gear box 128.

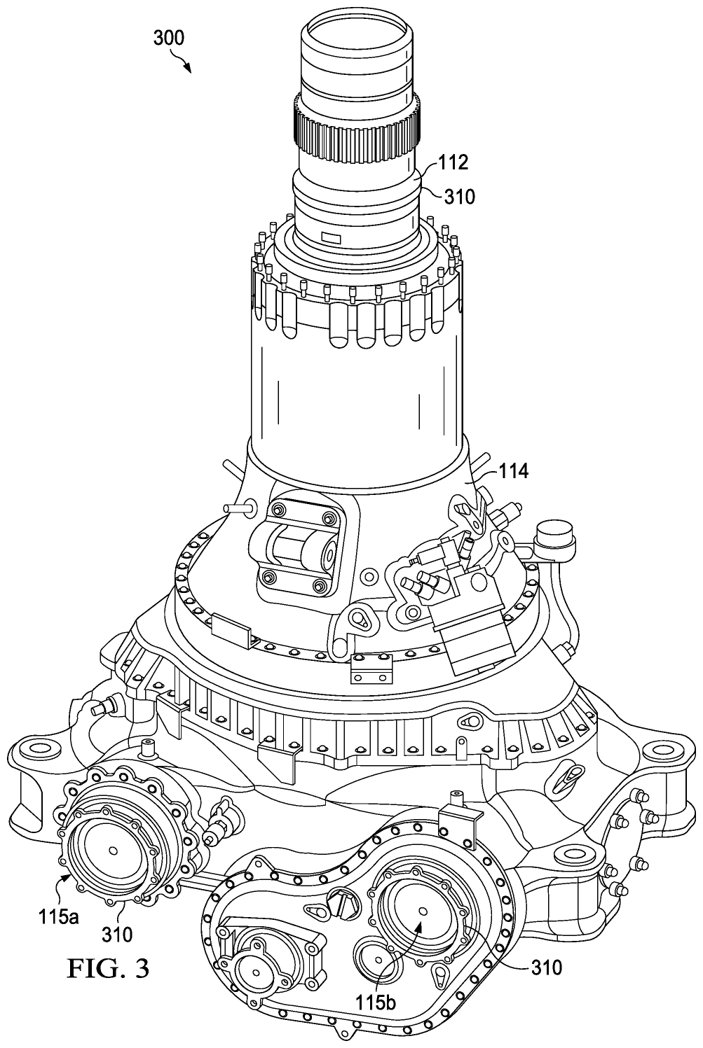

FIG. 3 illustrates a main rotor transmission system 300. Main rotor mast 112 is operably coupled to main rotor gearbox 114, which rotates main rotor mast 112 to turn rotor system 104 (see FIG. 1). Main rotor gearbox 114 also includes input 115a, 115b, which receive mechanical power provided by the engines 120a, 120b (see FIG. 2). Inputs 115a, 115b may receive power from the engines 120a, 120b directly or indirectly. For example, inputs 115a, 115b may receive power from the engines 120a, 120b through reduction gearboxes 216a, 216b (see FIG. 2). In an embodiment of the present invention, at least a portion of the surface of main rotor mast 112 is plated with zinc-nickel coating 310 to protect the plated portion from abrasion and/or corrosion that results from operation and exposure to the environment. In addition, or alternatively, at least a portion of the surface of inputs 115a, 115b are plated with a zinc-nickel coating 310 to protect the plated portion from abrasion or corrosion that results from operation and exposure to the environment. The skilled artisan will recognize generally that “coating” includes “plating,” and that the zinc-nickel coating 310 of main rotor mast 112, inputs 115a, 115b, or other components including a conductive material may include zinc-nickel plating. In one aspect, the nickel content is high, ranging from about 12 to 18%. In another aspect, the nickel content is about 15 to 18%. In another aspect, the nickel content is 18%. In another aspect, the zinc content is about 3 to 8%.

Examples of high-nickel content zinc-nickel coatings include those produced by processes such as those developed by Dipsol Chemicals Co., Ltd., Tokyo, Japan. One such process is IZ-250Y, which is an alkaline type, cyanide free, zinc nickel alloy electroplating process for use with, e.g., a rack plating bath. The deposit obtained by the IZ-250Y process is a uniform zinc alloy containing approximately 12 to 18% nickel (http://en.dipsol-jp.com/product/iz-250y#). Another process, IZ-252Y, is an alkaline type, cyanide free, zinc-nickel alloy electroplating process for, e.g., a barrel plating bath. The deposit obtained by the process IZ-252Y process also includes a uniform zinc-alloy containing approximately 12 to 18% nickel (http://en.dipsol-jp.com/product/iz-252y#). Each such process is incorporated herein by reference.

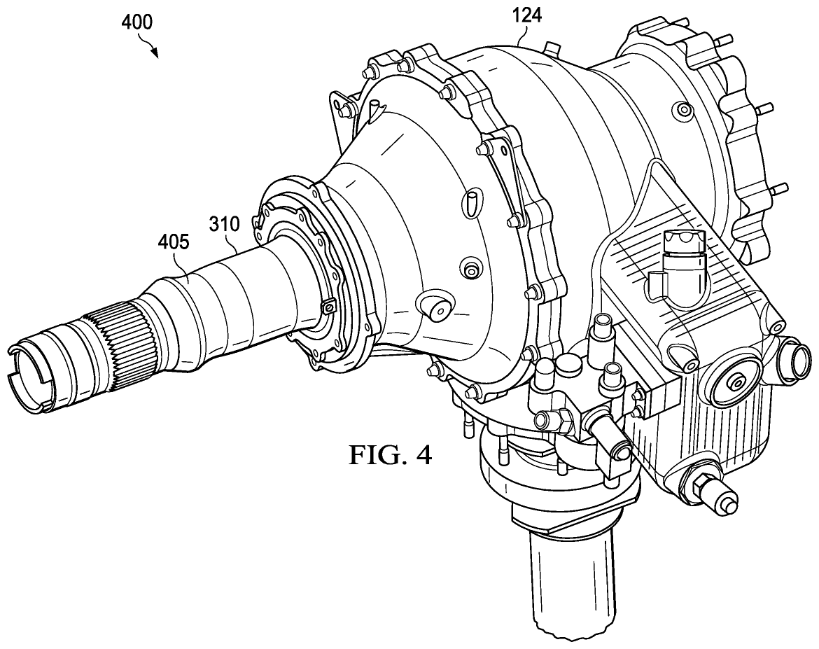

FIG. 4 depicts a tail rotor transmission system 400. Tail rotor mast 405 is operably coupled to tail rotor gearbox 124, which rotates tail rotor mast 405 to turn tail rotor 110 (see FIG. 1). In an embodiment of the present invention, at least a portion of the surface of tail rotor mast 405 is plated with zinc-nickel coating 310 as described in connection with FIG. 3 to protect the plated portion from abrasion or corrosion that results from operation and exposure to the environment. The skilled artisan will recognize that zinc-nickel coating 310 of tail rotor mast 405 or other components comprising a conductive material includes zinc-nickel plating, as described in connection with FIG. 3.

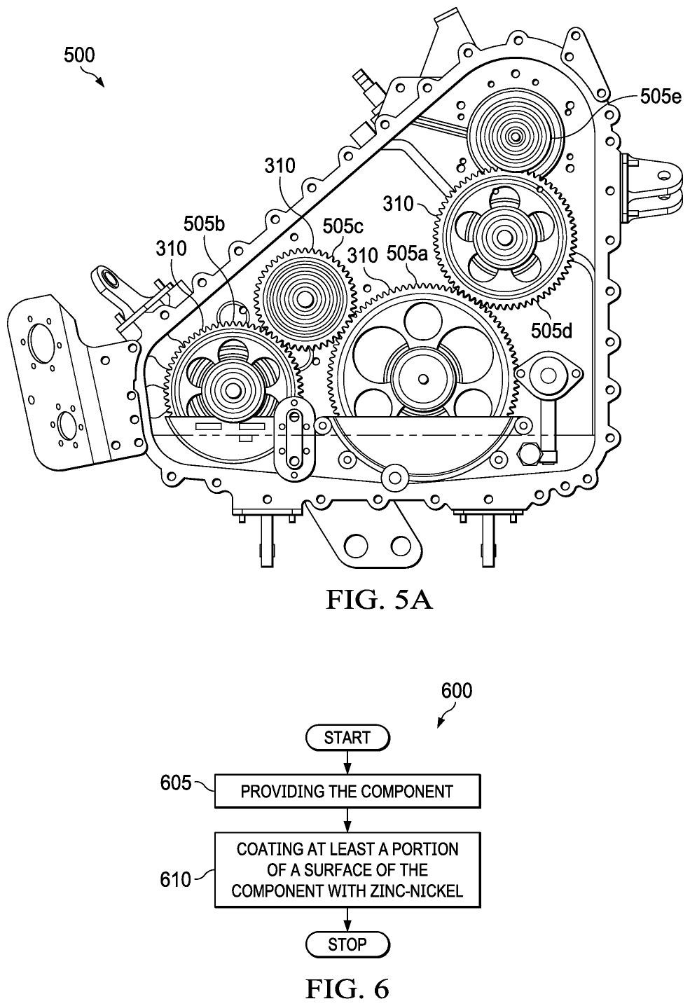

FIG. 5A depicts an interior view of an example gearbox 500 with an embodiment of the present invention. Gearbox 500 is equipped with gears 505a, 505b, 505c, 505d and 505e. In an embodiment of the present invention, at least a portion of a surface of one or more of gears 505a, 505b, 505c, 505d and 505e is plated with zinc-nickel coating 310 as described in connection with FIG. 3 to protect the plated portion from abrasion that results from operation. For example, FIG. 5B depicts a cross-sectional view of gearbox 500. Gear 505e protrudes from gearbox 500 and is coupled to fan blade assembly 510, as described more fully in U.S. patent application Ser. No. 15/709,502, which is fully incorporated by reference herein. At least a portion of the surface of gear 505e is plated with a zinc-nickel coating 310 to protect the plated portion from abrasion or corrosion that results from operation and exposure to the environment.

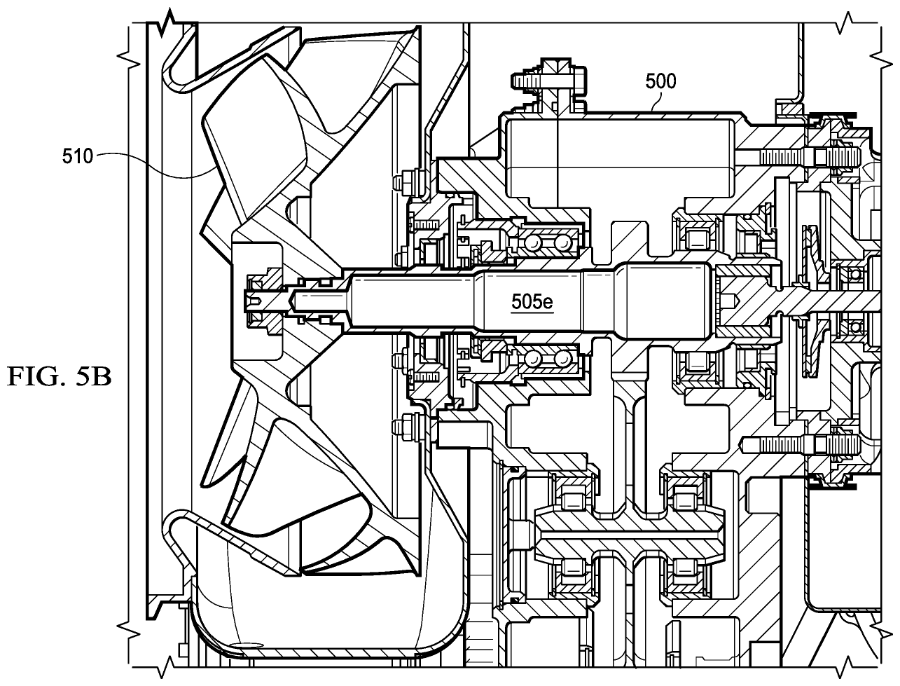

FIG. 6 depicts a flowchart of a method 600 of protecting a rotorcraft component that illustrates an embodiment of the present invention. Method 600 includes block 605, providing the rotorcraft component, and block 610, coating at least a portion of a surface of the rotorcraft component with zinc-nickel. In one aspect, the nickel content is high, ranging from about 12 to 18%. In another aspect, the nickel content is about 15 to 18%. In another aspect, the nickel content is 18%. In another aspect, the zinc content is about 3 to 8%. In another aspect, the rotorcraft component is a main rotor mast, a tail rotor mast, a gear, a main rotor gearbox, or one or more gears in an accessory gearbox, a reduction gearbox, an intermediate gearbox, or a tail rotor gearbox.

The skilled artisan will recognize that zinc-nickel coating 310 and method 600 protect rotorcraft components such as main rotor mast 112, tail rotor mast 405, and gears 505a, 505b, 505c, 505d and 505e from abrasion or corrosion.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are explicitly used in the particular claim.

What is claimed is:

1. A rotorcraft component protected from abrasion or corrosion, comprising:
the rotorcraft component; and
a zinc-nickel coating on at least a portion of a surface of the rotorcraft component, wherein the zinc-nickel coating protects the portion of the surface of the rotorcraft component from abrasion or corrosion.

2. The rotorcraft component of claim 1, wherein the zinc-nickel coating has a high nickel content, wherein a nickel content of the zinc-nickel coating is about 12 to 18%.

3. The rotorcraft component of claim 1, wherein a nickel content of the zinc-nickel coating is about 15 to 18%.

4. The rotorcraft component of claim 1, wherein a nickel content of the zinc-nickel coating is about 18%.

5. The rotorcraft component of claim 1, wherein a zinc content of the zinc-nickel coating is about 3 to 8%.

6. The rotorcraft component of claim 1, wherein the rotorcraft component is a main rotor mast, a tail rotor mast, a gear, a main rotor gearbox, or one or more gears in an accessory gearbox, a reduction gearbox, an intermediate gearbox, or a tail rotor gearbox.

7. A method of protecting a rotorcraft component from abrasion or corrosion, comprising:
providing the rotorcraft component; and
coating at least a portion of a surface of the rotorcraft component with a zinc-nickel coating.

8. The method of claim 7, wherein the zinc-nickel coating has a high nickel content, wherein a nickel content of the zinc-nickel coating is about 12 to 18%.

9. The method of claim 7, wherein a nickel content of the zinc-nickel coating is about 15-18%.

10. The method of claim 7, wherein a nickel content of the zinc-nickel coating is about 18%.

11. The method of claim 7, wherein a zinc content of the zinc-nickel coating is about 3 to 8%.

12. The method of claim 7, wherein the rotorcraft component is a main rotor mast, a tail rotor mast, a gear, a main rotor gearbox, or one or more gears in an accessory gearbox, a reduction gearbox, an intermediate gearbox, or a tail rotor gearbox.

13. A rotorcraft, comprising:
a fuselage;
one or more engines coupled to the fuselage; and
a component coupled to the one or more engines, comprising a zinc-nickel coating on at least a portion of a surface of the component, wherein the zinc-nickel coating protects the portion of the surface of the component from abrasion or corrosion.

14. The rotorcraft of claim 13, wherein the zinc-nickel coating has a high nickel content, wherein a nickel content of the zinc-nickel coating is about 12 to 18%.

15. The rotorcraft of claim 13, wherein a nickel content of the zinc-nickel coating is about 15-18%.

16. The rotorcraft of claim 13, wherein a nickel content of the zinc-nickel coating is about 18%.

17. The rotorcraft of claim 13, wherein a zinc content of the zinc-nickel coating is about 3 to 8%.

18. The rotorcraft of claim 13, wherein the component is a main rotor mast, a tail rotor mast, a gear, a main rotor gearbox, or one or more gears in an accessory gearbox, a reduction gearbox, an intermediate gearbox, or a tail rotor gearbox.
